(19) United States
(12) Patent Application Publication
(10) Pub. No.: US 2021/0368026 A1
(43) Pub. Date: Nov. 25, 2021

(54) DATA TRANSMISSION DEVICE, PROGRAM, AND SYSTEM

(71) Applicants: DAISUKE EMURA, Fujisawa-Shi (JP); TVT CO., LTD., Shibuya-Ku (JP); SHINONOMEKAZAN CO., LTD., Chuo-Ku (JP); LOPPO LLC, Kawasaki-Shi (JP); METAMAGIC CO., LTD., Sapporo-Shi (JP)

(72) Inventor: Daisuke EMURA, Fujisawa-shi (JP)

(21) Appl. No.: 17/347,602

(22) Filed: Jun. 15, 2021

Related U.S. Application Data
(63) Continuation of application No. PCT/JP2020/020250, filed on May 22, 2020.

(51) Int. Cl. H04L 29/06; G06F 9/52

(52) U.S. Cl. CPC H04L 69/04; G06F 9/52

(57) ABSTRACT

The data transmission device (2) of the present invention comprises a data dividing section (212) for dividing data to be transmitted into a plurality of divided data pieces; an identification information assignment section (213) for associating identification information for identifying the plurality of divided data pieces with each of the plurality of divided data pieces; and a data processing section (214) for assigning a group of data processing for the plurality of divided data to any of a plurality of threads (211) capable of parallel processing to be executed, wherein the group of data processing includes: a transmission data preparation process of compressing specified divided data pieces among the plurality of divided data pieces and preparing a plurality of transmission data pieces associated with the identification information.

### TECHNICAL FIELD

The present invention relates to a data transmission device, program, and system.

### BACKGROUND

There is an increasing demand for transmitting and receiving data via an internetwork, and transmission and reception of large-capacity data such as application programs, audio data, and moving image data are also increasing. Accordingly, there is an increasing demand for reducing the amount of data to be communicated and effectively using a communication band which is a limited resource.

Further, with the spread of remote work and telework, the demand for real-time communication, which is instantaneous information transmission, such as voice communication (voice chat) and voice communication with video (video chat) via an internetwork has also increased in recent years. In such communication, if there is a time difference between the transmission side and the reception side, a problem occurs in mutual understanding between users.

As a method for reducing the amount of data to be transmitted and received and reducing the communication delay, there is a method of compressing data to be transmitted and received. For example, Patent Literature 1 discloses an image data processing system that can be used in an industrial single-pass inkjet printer or the like connected by PCIe (registered trademark).

### SUMMARY

In the decompression processing, in the case of attempting to shorten the processing time by using a plurality of decompression circuits for a plurality of compressed data obtained by dividing and compressing the original data, since the time required for the decompression processing becomes shorter than in the case of using one decompression circuit, the opportunity that the reception device can receive the compressed data whose reception is delayed during the decompression processing decreases. As a result, the compressed data whose reception is delayed may be received after a while after the decompression is completed. In such reception, the time from the end of decompression processing to the reception of the delayed compressed data is added to the communication delay and increases the communication delay. Therefore, the delay in reception of a part of the compressed data has a greater effect on the overall communication delay than in the case of a system in which the time for performing decompression processing is long. Therefore, there is room for further improvement in terms of communication delay when realizing a system on an inter-network that effectively utilizes a communication band by reducing the amount of data transmitted by dividing, compressing, and transmitting data on the transmission side.

The present invention has been made in view of such circumstances, and an object of the present invention is to provide a data transmission device and the like which can reduce the amount of data to be communicated to effectively utilize the communication band and reduce the communication delay at the same time.

### Means for Solving the Problems

As a result of diligent study of the aforementioned problems, the inventors have found that it is possible to achieve the aforementioned objective by dividing data to be transmitted into a plurality of divided data and performing a group of data processing including compression of specified divided data, association of identification information, and transmission using a communication system without guarantee of data delivery order by using a plurality of threads capable of parallel processing.

The present invention provides a data transmission device comprising a data dividing section for dividing data to be transmitted into a plurality of divided data pieces; an identification information assignment section for associating identification information for identifying the plurality of divided data pieces with each of the plurality of divided data pieces; and a data processing section for assigning a group of data processing for the plurality of divided data to any of a plurality of threads capable of parallel processing to be executed, wherein the group of data processing includes: a transmission data preparation process of compressing specified divided data pieces among the plurality of divided data pieces and preparing a plurality of transmission data pieces associated with the identification information; and a transmission process of transmitting the plurality of transmission data pieces to an outside by a communication system without guarantee of data delivery order.

According to the present invention, since the communication system without guarantee of data delivery order is used, it is possible to solve the problem that a delay in receiving a part of compressed data included in the communication system with guarantee of data delivery order causes a delay in receiving all the compressed data transmitted thereafter, thereby further increasing the communication delay. According to the present invention, the receiving side that has received the transmission data can reconstruct the data to be transmitted using the identification information regardless of the order in which the data is received. By associating the identification information; it is possible to simultaneously solve the problem caused by performing the transmission data preparation process and the transmission process using a plurality of threads that can be processed in parallel and the problem caused by using a communication system without guarantee of data delivery order. Therefore, according to the present invention, it is possible to simultaneously achieve effective use of a communication band by reducing the amount of data to be communicated by compression and communication delay reduction by reducing decompression time with parallel processing with a communication system without guarantee of data delivery order while avoiding harmful side effects of not guaranteeing the order in which data is received.

### Effect of the Invention

According to the present invention, it is possible to provide a data transmission device, a program, and a data communication system that simultaneously realize effective use of a communication band by reducing an amount of data to be communicated and reduction of communication delay.

### BRIEF DESCRIPTION OF DRAWINGS

FIG. 1 is a block diagram illustrating an example of a configuration of a data communication system 1 according to the present embodiment.

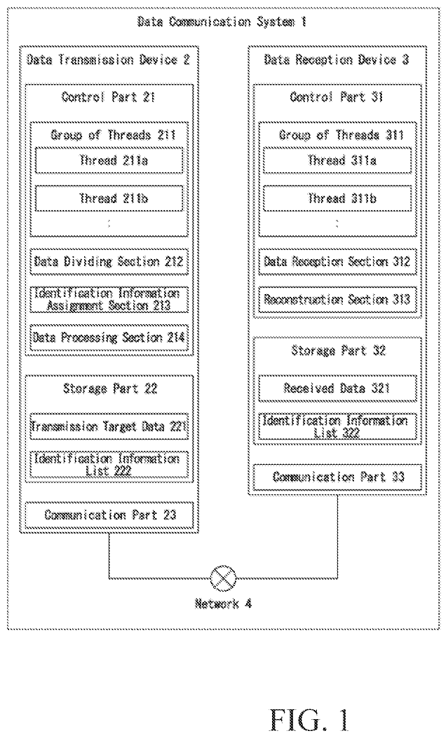

FIG. 2 is a main flowchart illustrating an example of the flow of data transmission using the data transmission device 2 of the present embodiment.

FIG. 3 is a conceptual diagram illustrating an example of data division using the data transmission device 2 of the present embodiment.

FIG. 4 is an example of the transmission target data 221 and the identification information list 222 according to the present embodiment.

FIG. 5 is a flowchart illustrating an example of the flow of data processing executed by the thread 211 capable of parallel processing according to the present embodiment.

FIG. 6 is a conceptual diagram illustrating an example of transmission data transmitted by the data processing section according to the present embodiment.

FIG. 7 is a conceptual diagram illustrating an example of a parallel processing in data processing according to the present embodiment.

FIG. 8 is a main flowchart illustrating an example of the flow of data reception using the data reception device 3 of the present embodiment.

FIG. 9 is an example of the received data 321 according to the present embodiment.

FIG. 10 is a flowchart illustrating an example of the flow of data reception executed by the thread 311 capable of parallel processing according to the present embodiment.

FIG. 11 is a conceptual diagram illustrating an example of a parallel processing in data reception according to the present embodiment.

FIG. 12 is a conceptual diagram illustrating an improvement in delay time according to the present invention.

FIG. 13 is a main flowchart illustrating an example of the flow of data reception using the data reception device 3 of the modified example 1

FIG. 14 is a main flowchart illustrating an example of the flow of data reception using the data reception device 3 of the modified example 2.

### DETAILED DESCRIPTION

In the following, description is given of an example of a preferred aspect for carrying out the present invention with reference to the figures. It is to be noted that this is merely an example and the technical scope of the present invention is not limited thereto.

### <Data Communication System 1>

A data communication system 1 (hereinafter also simply referred to as a system 1) includes a data transmission device 2 (hereinafter also simply referred to as a transmission device 2), a data reception device 3 (hereinafter also simply referred to as a reception device 3), and a network 4.

### [Data Transmission Device 2]

The transmission device 2 includes a control part 21, a storage part 22, and a communication part 23. It is preferable that the transmission device 2 can execute various programs for transmitting data. Examples of the various programs for transmitting data include programs for realizing audio chat, video chat, a moving image data distribution server, an audio data distribution server, a Web server, a data distribution server, a SAN, a NAS, a file server, a cloud storage, a mail server, and the like. Since the data transmission device 2 can execute various programs for transmitting data, the amount of data transmitted by these various programs can be reduced to use the communication band effectively, and the communication delay can be reduced.

### [Control Part 21]

The control part 21 includes a CPU, a RAM, a ROM, and the like. It is preferable that the control part 21 can use hardware multithreading. The CPU is preferably a multi-core CPU. The control part 21 may include a vector processor or an array processor. The vector processor or array processor may be a GPU. A widely available GPU in the market can realize a vector processor at a relatively low cost. Since the control part 21 includes a multi-core CPU, a vector processor, an array processor, and the like that can realize hardware multithreading at high speed, the control part 21 can achieve faster execution of threads capable of parallel processing. By realizing the faster execution of threads capable of parallel processing, the compression processing described later can be executed in a shorter time, and the communication delay can be reduced.

The control part 21 reads a predetermined program and cooperates with the storage part 22 and/or the communication part 23 as necessary to realize a group of threads 211, a data dividing section 212, an identification information assignment section 213, a data processing section 214, and the like which are elements of the software configuration in the transmission device 2.

The group of threads 211 is a component that realizes parallel processing on a computer, and simultaneously executes a group of processing to which a plurality of threads of the group of threads 211 are allocated by parallel processing. The thread mechanism that realizes the group of threads 211 is not particularly limited, and examples thereof include thread mechanisms of existing technologies such as a user thread and a kernel thread. It is preferable that the group of threads 211 includes a thread mechanism capable of using hardware multithreading. The group of threads 211 is preferably capable of executing asynchronous parallel processing. If asynchronous parallel processing can be executed, it is possible to prevent an increase in communication delay without spending time for synchronization of parallel processing. It is preferable that the group of threads 211 does not virtualize the address space for each processing unit and does not separate the address space. By not performing virtualization and or separation, extra time associated with virtualization and separation is not required, and communication delay can be reduced. Since the group of threads 211 executes a group of allocated processes by parallel processing, a plurality of processes can be performed simultaneously. Therefore, the time until the completion of the processing can be shortened compared with the case where the parallel processing is not performed, and the communication delay can be reduced.

### [Storage Part 22]

The storage part 22 is a device in which data and files are stored, and includes a data storage part such as a hard disk, a semiconductor memory, a recording medium, or a memory card. The storage part 22 may have a mechanism that enables connection with a storage device or a storage system such as a NAS, a SAN, a cloud storage, a file server, or a distributed file system via a network. The storage part 22 stores a control program executed by the microcomputer, transmission target data 221, an identification information list 222, and the like.

### [Communication Part 23]

The communication part 23 includes a device for enabling the transmission device 2 to communicate with the reception device 3 and other devices. The types of devices are not particularly limited, and include, for example, network cards compliant with the Ethernet standard, Wi-Fi device compliant with IEEE 802.11, and the like. In order to exchange a large amount of data, the communication part 23 preferably has a network card corresponding to the Ethernet standard.

### [Data Reception Device 3]

The data reception device 3 includes a control part 31, a storage part 32, and a communication part 33. It is preferable that the data reception device 3 can execute various programs for receiving data. Examples of the various programs for receiving data include programs for realizing voice chat, video chat, video data distribution server, software that plays back video data, voice data distribution server, software that plays back voice data, web server, software that obtains data from a web server software, data distribution server, software to retrieve data from data distribution server, SAN, software to retrieve data from SAN, NAS, software to retrieve data from NAS, file server, software to retrieve data from file server, cloud storage Software to acquire data from a cloud storage server, software to acquire data from a cloud storage server, mail server, software to acquire mail from a mail server, etc. Since the data reception device 3 can execute various programs for receiving data, the amount of data received by these various programs can be reduced to use the communication band effectively, and the communication delay can be reduced.

### [Control Part 31]

The hardware configuration of the control part 31 is the same as that of the control part 21. The control part 31 reads a predetermined program and cooperates with the storage part 32 and/or the communication part 33 as necessary to realize a group of threads 311, a data reception section 312, a reconstruction section 313, and the like which are elements of the software configuration in the reception device 3. The group of threads 311 is similar to the group of threads 211.

### [Storage Part 32]

The hardware configuration of the storage part 32 is the same as that of the storage part 22. The storage part 32 stores received data 321, an identification information list 322, and the like.

### [Communication Part 33]

The communication part 33 includes a device for enabling the reception device 3 to communicate with the transmission device 2 and other devices. The hardware configuration of the communication part 33 is the same as that of the communication part 23,

### [Network 4]

The network 4 connects the transmission device 2 and the reception device 3. The type of the network 4 is not particularly limited, and examples thereof include a personal area network, a local area network, an intranet, an extranet, the Internet, a Wi-Fi network, and a network obtained by combining a plurality of networks including these networks.

### [Main Flowchart of Data Transmission]

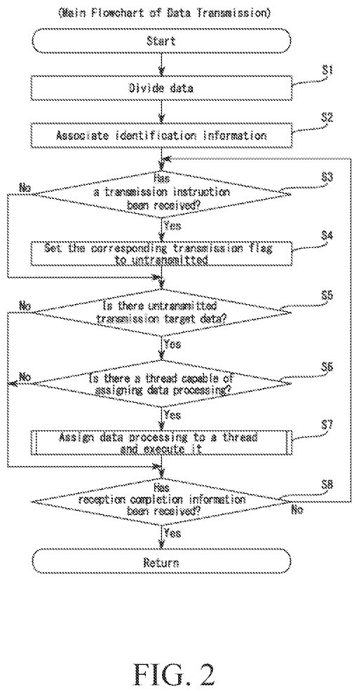

Hereinafter, with reference to FIG. 2, description is given of an example of a preferred procedure of the data transmission performed by the transmission device 2.

### [Step S1: Divide Data]

When data transmission is commanded for a transmission target data to be transmitted, the control part 21 executes the data dividing section 212 in cooperation with the storage part 22 to divide the transmission target data into a plurality of divided data (Step S The control part 21 shifts the processing to step S2. The divided data preferably has a data amount equal to or less than a value obtained by subtracting a predetermined data amount from an upper limit of a transmission data amount in one data transmission according to the communication system. The type of transmission target data is not limited. Examples of the transmission target data include document data, audio data, image data, moving image data, archive data, a program for realizing application software or the like, a program or data for realizing an installer, data used by application software, data for adding a function to application software, data for changing a function of application software, data for rewriting a BIOS, and an instruction or an instruction group for instructing a specific operation or a series of operations to a receiving computer.

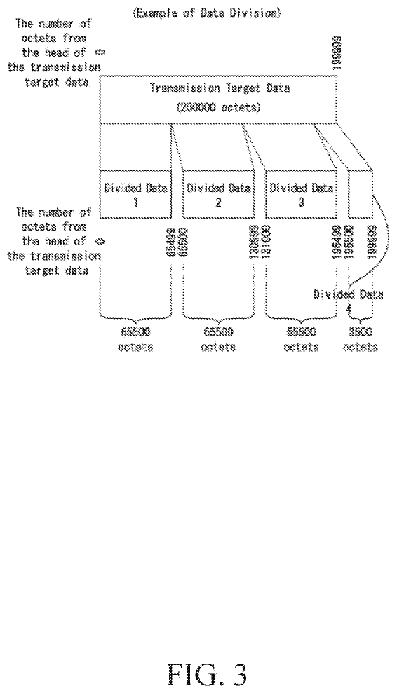

FIG. 3 shows an example of the division of data to be transmitted to be performed in step S1. FIG. 3 shows an example of data division in the case where a communication system combining in which the upper limit of the transmission data amount in one data transmission is 65535 octets and the data amount of the header is 20 octets and UDP in which the data amount of the header is 8 octets is used and the data amount of the header added at the time of compression is 7 octets. The data dividing section 212 divides the transmission target data based on the upper limit of the amount of transmission data and the data amount of the header so that the data amount of the divided data becomes 65500 octets or less. By dividing the data in this way, the data amount of the transmission data generated by the data processing described later becomes equal to or less than the upper limit data amount of 65535 octets in one data transmission defined by the IP, and it is not necessary to perform additional division in order to set the data amount to be equal to or less than the upper limit, and it is possible to prevent an increase in delay time due to the division.

### [Step S2: Associate Identification Information]

Turn back to FIG. 2. The control part 21 executes the identification information assignment section 213 in cooperation with the storage part 22, and associates the identification information with the divided data generated in step S1 (Step S2). The control part 21 shifts the processing to step S3. The identification information assignment section 213 may further perform a process of generating an identification information list that is a list of identification information and transmitting the identification information list to the outside such as the reception device 3. The identification information is not particularly limited while the original data can be reconstructed from the divided data. Examples of the identification information include a serial number assigned to the divided data, information in which a serial number assigned to the divided data and the number of divisions are paired, an address number in the original data of the data of the head address of the divided data, and a pair of an address number in the original data of the data of the head address of the divided data and the data amount of the original data.

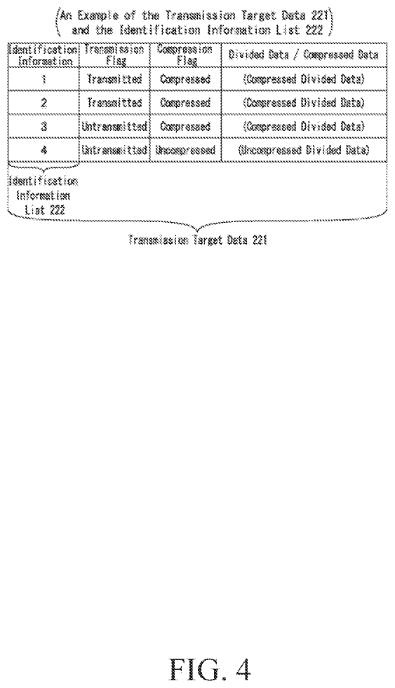

FIG. 4 is an example of the transmission target data 221 and the identification information list 222. The transmission target data 221 includes identification information for identifying the divided data and enabling reconstruction, a transmission flag for storing whether the transmission data related to the divided data has been transmitted or has not been transmitted, a compression flag for storing whether the divided data has been compressed, and divided data/compressed data for storing the divided data and/or the compressed data. In step S2, the identification information assignment section 213 preferably sets the transmission flag to indicate non-transmission and sets the compression flag to indicate non-compression. The identification information list 222 may be stored in the same table as the transmission target data 221 as in the example illustrated in FIG. 4, may be stored in another table, or may be stored in a plurality of tables.

[Step S3: Determine Whether a Transmission Instruction has been Received]

Turn back to FIG. 2. The control part 21 executes the data processing section 214 in cooperation with the storage part 22, and determines whether or not a transmission instruction has been received from the outside (Step S3). If it is received, the control part 21 shifts the processing to step S4. If it is not received, the control part 21 shifts the processing to step S5 By determining whether or not the transmission instruction has been received from the outside, even if a part or all of the transmitted transmission data is lost during transmission due to a communication failure or the like, the transmission data can be transmitted according to the received transmission instruction.

### [Step S4: Set the Corresponding Transmission Flag to Untransmitted]

The control part 21 executes the data processing section 214 in cooperation with the storage part 22, and sets the transmission flag stored in the transmission target data 221 for the data to be transmitted indicated by the transmission instruction to indicate untransmitted (step S4), The control part 21 shifts the processing to step S5. The transmission instruction may indicate the transmission data to be transmitted by listing identification information related to the transmission data to be transmitted, may indicate the transmission data to be transmitted by listing identification information related to the transmission data to be excluded from the transmission data, may indicate the transmission data to be transmitted by information indicating the range of the transmission data to be transmitted. Transmission data to be transmitted may be indicated by combining these methods.

[Step S5: Determine Whether there is an Untransmitted Transmission Target Data]

The control part 21 executes the data processing section 214 in cooperation with the storage part 22, and determines whether or not there is any transmission data for which the transmission flag indicates untransmitted (Step S5). If there is a transmission data indicating untransmitted, the control part 21 shifts the processing to step S6. If there are no transmission data indicating untransmitted, the control part 21 shifts the processing to step S8.

[Step S6: Determine Whether there is a Thread Capable of Assigning Data Processing]

The control part 21 executes the data processing section 214 in cooperation with the storage part 22, and determines whether or not there is any thread 211 capable of assigning data processing (Step S6). If there is a corresponding thread 211, the control part 21 shifts the processing to step S7. If there are no corresponding threads 211, the control part 21 shifts the processing to step S8.

### [Step S7: Assign Data Processing to a Thread and Execute It]

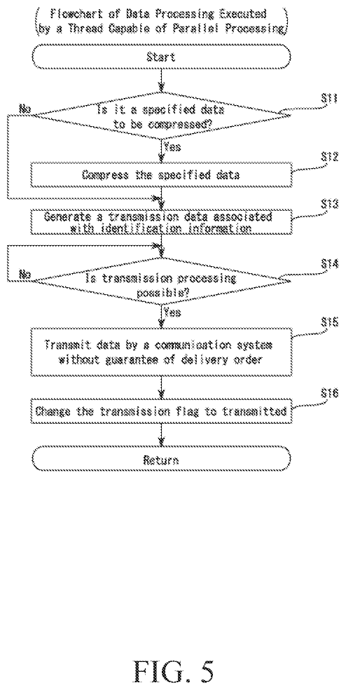

The control part 21 executes the data processing section 214 in cooperation with the storage part 22, and assigns and executes a group of data processing for the divided data to any of the threads included in the group of threads 211 capable of assigning data processing (step S7). The control part 21 shifts the processing to step S8. Details of step S7 will be described later with reference to FIG. 5.

[Step S8: Determine Whether Reception Completion Information has been Received]

The control part 21 executes the data processing section 214 in cooperation with the storage part 22, and determines whether or not reception completion information has been received (Step S8). If it has been received, the control part 21 ends the processing, waits for data transmission related to other transmission target data, and repeats steps S1 to S8. If it has not been received, the control part 21 shifts the processing to step S3. By determining whether or not the reception completion information has been received, transmission of the transmission data is continued until the reception side receives all the transmission data and transmits the reception completion information. Therefore, the transmission will not be terminated before the receiving side receives all the transmission data and the receiving side will not be unable to use the transmission target data due to lack of transmission data.

### [Flowchart of Data Processing]

FIG. 5 is a flowchart illustrating an example of the flow of data processing executed by the thread capable of parallel processing according to the present embodiment.

[Step S11: Determine Whether it is a Specified Data that Requires Compression]

When the execution of the group of data processing is allocated to any one of the threads included in the group of threads 211, the control part 21 executes the data processing section 214 in cooperation with the storage part 22, and determines whether or not the divided data is a specified data that requires compression (step S11). If it is a specified data, the control part 21 shifts the processing to step S12. If it is not a specified data, the control part 21 shifts the processing to step S13. By determining whether or not it is the specified data, it can compress only the specified data requiring compression, and communication delay can be reduced. The determination of whether or not the data is the specified data is not particularly limited. For example, a determination that the data is not the specified data when the compression flag indicates compressed, a determination that the data is not the specified data when the data amount of the divided data is equal to or less than a specified data amount, a determination that the data is a combination of these determinations, and the like are exemplified.

### [Step S12: Compress the Specified Data]

The control part 21 executes the data processing section 214 in cooperation with the storage part 22, and compresses the specified data, and changes the corresponding compression flag to compressed (Step S12). The control part 21 shifts the processing to step S13.

A method of compressing data is not particularly limited. The method of compressing data includes, for example, any one or more of a method based on entropy coding, a method based on dictionary coding, and a method including both entropy coding and dictionary coding. Techniques for compressing data may include BWT. CTW, differential encoding, DMC, differential pulse code modulation, MTF, PAQ, PPM, RLE, etc. The compression method preferably includes a method using the lz4fast algorithm, which has a compression rate almost equivalent to that of LZO (Lempel-Ziv-Oberhumer) having an excellent decompression speed, but has a better compression speed than LZO, and can change the trade-off relationship between the compression speed and the compression rate to make the communication delay smaller, depending on the processing capacity of the control part 21 and the communication situation.

The method of compressing the data may assign a header storing information related to the compression to the compressed specified data. The header related to the compression includes, for example, a compression method, a data amount before compression, a compression ratio, a checksum, and the like. By adding a header storing information related to the compression, the receiving side such as the reception device 3 can perform decompression process using information related to the compression.

[Step S13: Generate a Transmission Data Associated with Identification Information]

The control part 21 executes the data processing section 214 in cooperation with the storage part 22, and generates transmission data in which the identification information is associated with the specified data compressed in step S12 or the divided data that is not the specified data (step S13). The control part 21 shifts the processing to step S14. In a case where the amount of the specified data compressed in step S12 is larger than the amount of the divided data before being compressed, it is preferable to generate the transmission data by associating the divided data before being compressed with the identification information. The transmission data may include information related to the compression method.

### [Step S14: Determine Whether or not Transmission Processing is Possible]

The control part 21 executes the data processing section 214 in cooperation with the storage part 22, and determines whether or not transmission processing is possible (Step S14). If it is possible, the control part 21 shifts the processing to step S15. If it is not possible, the control part 21 repeats step S14. The control part 21 may repeat step S14 after waiting for a predetermined time. By waiting for the predetermined time, the burden on the control part 21 and the communication part 23 due to the determination as to whether or not the transmission processing is possible is reduced, and the execution speed and the time required for processing of another thread using the same control part 21 and communication part 23 can be improved, thereby preventing an increase in the entire execution time.

[Step S15: Transmit Data by a Communication System without Guarantee of Delivery Order]

The control part 21 executes the data processing section 214 in cooperation with the storage part 22 and the communication part 23, and transmits the transmission data to the outside such as the reception device 3 by a communication system without guarantee of delivery order (step S15). The control part 21 shifts the processing to step S16. The communication system without guarantee of delivery order is not particularly limited. Examples of the communication system without guarantee of delivery order include a communication method including one or more of UDP, SCTP, and DCCP of a communication protocol corresponding to a transport layer. The communication system without guarantee of delivery order may include a communication protocol corresponding to the Internet layer. The communication system without guarantee of delivery order preferably includes IP. By including the IP, communication using an existing internetwork using the IP can be performed.

Since the communication system includes the UDP, unlike the communication method including the TCP, it is not necessary to perform a special setting regarding a transfer channel or a data path in advance. Therefore, the communication delay can be further reduced. Since UDP is a simple communication protocol, it is possible to realize transmission processing by a communication system without guarantee of delivery order using an existing internetwork and an existing device therefor without preparing a special device or network. Unlike TCP, MPTCP, and DCCP, which can be used instead of UDP, UDP does not perform flow control. When flow control is performed, communication delay may increase. Since the communication system includes the UDP, the communication delay can be reduced as compared with the case of using these communication systems. The data amount of the UDP header is 8 octets, which is smaller than the data amount of a TCP header having a standard data amount of 20 octets, an MPTCP header having a standard data amount of 52 octets, or a DCCP header having a standard data amount of 16 octets. Since the communication system includes the UDP, the data amount of the header to be added becomes small, so that the communication band can be effectively utilized by reducing the data amount to be transmitted.

Since the communication system includes the SCTP, even when a network failure occurs, transmission and reception can be resumed in a relatively short time by a restoring force from the failure. That is, it is possible to suppress a communication delay at the time of occurrence of a network failure. In addition, if data is lost due to a network failure, the lost data cannot be used until the lost data is transmitted again and received, and thus a communication delay increases. However, since the SCTP has reliability more reliably ensuring the arrival of data, such an increase in communication delay can be suppressed. The data amount of the SCTP header is 12 octets, which is smaller than the data amount of the TCP header, the MPTCP header, and the DCCP header. Therefore, the amount of data to be communicated can be reduced and the communication band can be effectively used as compared with the case where TCP, MPTCP, or DCCP is used.

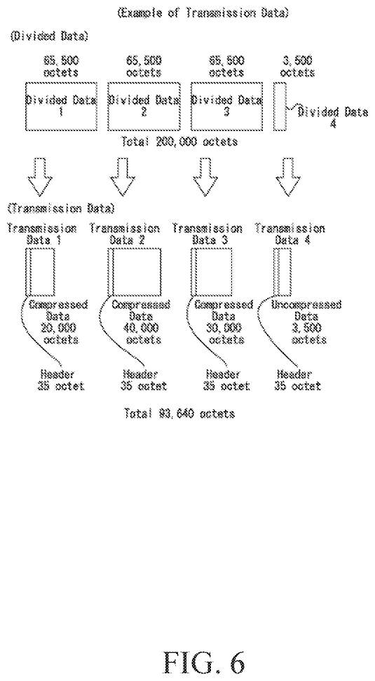

FIG. 6 shows an example of transmission data related to the divided data shown in FIG. 3, The divided data 1 to 3 are compressed, respectively. Since the divided data 4 is not specified data, it is not compressed and remains as uncompressed data. Each of these data is associated with a header of 35 octet. The total amount of data to be transmitted is 93640 octets, which is smaller than 200000 octets of transmission target data. Therefore, the amount of data to be communicated can be reduced and the communication band can be effectively used.

### [Step S16: Change the Transmission Flag to Transmitted]

Turn back to FIG. 5. The control part 21 executes the data processing section 214 in cooperation with the storage part 22 and the communication part 23, and changes the transmission flag corresponding to the transmission data transmitted in step S15 to indicate transmitted (step S16). The control part 21 ends the processing and waits until execution of the next group of data processing is assigned to the thread 211.

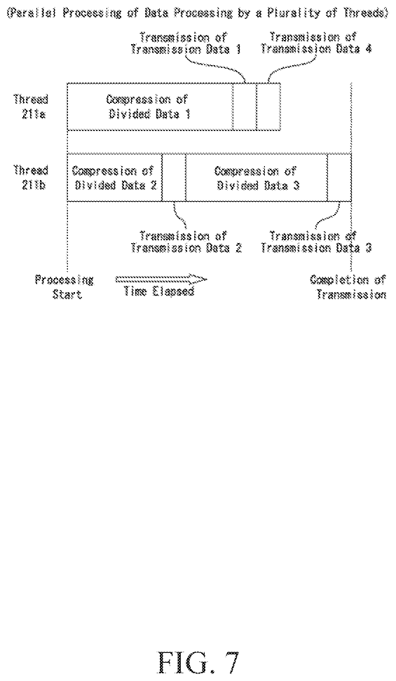

FIG. 7 is a conceptual diagram illustrating parallel processing of a group of data processing of steps S11 to S16 allocated to threads capable of parallel processing. In this example, the group of threads 211 includes two threads (a thread 211a and a thread 211b). As shown in FIG. 7, since many transmission processes are executed at the same time as compression processes of other threads that do not perform transmission processes, they do not increase the processing time until transmission completion. Therefore, the time from the start of processing to the completion of transmission is shortened, and the communication delay can be reduced. Although FIG. 7 shows a case where the group of threads 211 includes two threads, it will be understood that if the number of threads is larger, the number of compression processes executed by other threads that are not performing transmission processes during transmission processes increases, and the time from the start of the process to the completion of the transmission becomes shorter.

Since the transmission device 2 divides and compresses the transmission target data in the above-described procedure from step S1 to step S16 and transmits the transmission target data, it is possible to provide a data transmission device that can reduce the amount of data to be transmitted to effectively use the communication band and reduce the communication delay at the same time.

### [Main Flowchart of Data Reception]

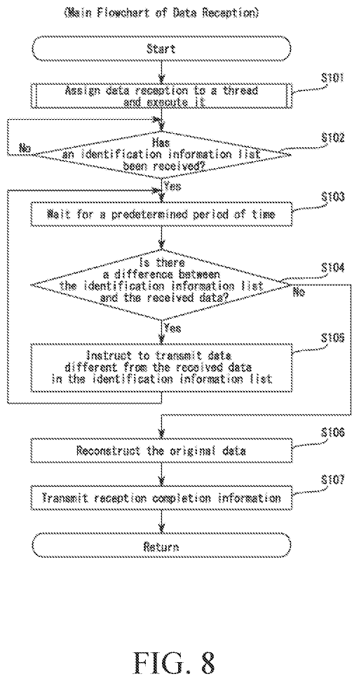

Hereinafter, with reference to FIG. 8, description is given of an example of a preferred procedure of the data reception performed by the reception device 3.

### [Step S101: Assign Data Processing to a Thread and Execute It]

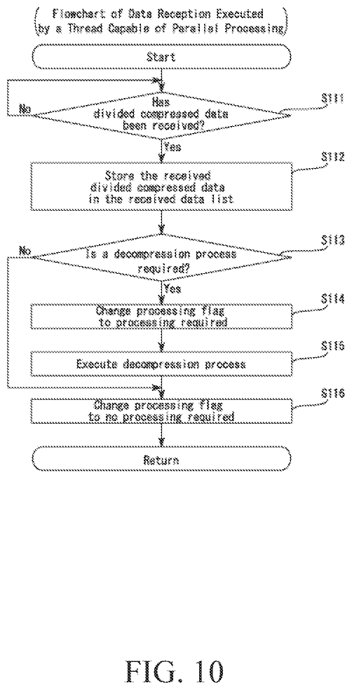

The control part 31 executes the data reception section 312 in cooperation with the storage part 32, and assigns and executes a group of data reception to a thread 311 capable of a group of data reception (step S101). The control part 31 shifts the processing to step S102. Details of step S101 will be described later with reference to FIG. 10.

[Step S102: Determine Whether an Identification Information List has been Received]

The control part 31 executes the data reception section 312 in cooperation with the storage part 32 and the communication part 33, and determines whether or not an identification information list has been received (Step S102). If it has been received, the control part 31 stores the identification information list in the identification information list 322 in cooperation with the storage part 32, and shifts the processing to step S103. If it has not been received, the control part 31 repeats step S102.

### [Step S103: Wait for a Predetermined Time to Elapse]

The control part 31 executes the data reception section 312 in cooperation with the storage part 32, and waits for a predetermined time to elapse(Step S103). The control part 31 shifts the processing to step S104. By waiting for a predetermined time, it is possible to prevent an increase in the amount of data to be communicated due to the continuous transmission of the transmission commands described below. The control part 31 may wait for the predetermined time elapses, the control part 31 may wait for the processing until the thread synchronization object that synchronizes the threads of the group of threads 311 executes a predetermined operation related to the synchronization of the threads. By waiting for the processing until a predetermined operation related to the synchronization of the threads is executed, the synchronization processing of the threads of the group of threads 311 is performed more effectively, and the communication delay can be reduced. The process may wait until an exclusive control container that controls access to the received data 321, the identification information list 322, or the like executes a predetermined operation related to exclusive control of access. By waiting until a predetermined operation related to exclusive control of access is executed, access to the received data 321, the identification information list 322, and the like is more effectively performed, and communication delay can be reduced. The thread synchronization object preferably includes any one of Mutex, Semaphore, and Event, or an object inheriting any one of them. The exclusive control container preferably includes any one of Queue, Stack, List, and Vector or a container inheriting any one of them.

[Step S104: Determine Whether there is a Difference Between the Identification Information List and the Received Data]

The control part 31 executes the data reception section 312 in cooperation with the storage part 32, and determines whether or not there is a difference between the identification information list 322 and the received data 321 described below (Step S104). If there is a difference, the control part 31 shifts the processing to step S105. If there are no difference, the control part 31 shifts the processing to step S106.

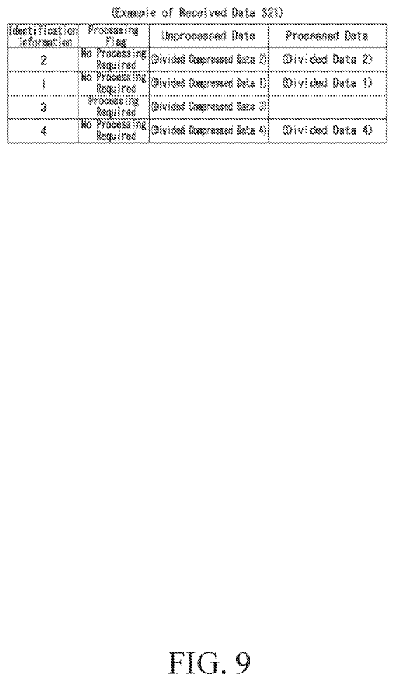

FIG. 9 is an example of the received data 321. The received data 321 includes identification information for identifying the divided compressed data and enabling reconstruction, a processing flag indicating whether decompression processing is necessary for the divided compressed data, unprocessed data for storing the received divided compressed data, and processed data for storing the divided data obtained by performing decompression process on the divided compressed data. The identification information is not limited while it is an information capable of reconstructing the original data from the divided data.

[Step S105: Instruct to Transmit Data Different from the Received Data in the Identification Information List]

Turn back to FIG. 8. The control part 31 executes the data reception section 312 in cooperation with the storage part 32 and the communication part 33, and instructs the outside that has transmitted the identification information list to transmit divided compressed data that is different from the identification information stored in the received data 321 in the identification information list (step S105). The control part 31 shifts the processing to step S103. By instructing the transmission of the divided compressed data different from the identification information stored in the received data 321 in the identification information list, even if a part or all of the divided compressed data is lost during transmission through the network 4 due to a communication failure or the like, the transmission of the lost divided compressed data can be instructed and received.

### [Step S106: Reconstruct the Original Data Using Identification Information]

The control part 31 executes the reconstruction section 313 in cooperation with the storage part 32, and reconstructs the original data using identification information (Step S106). The control part 31 shifts the processing to step S107. It is preferable that the reconstruction section 313 proceeds in order from the reconstruction of the divided data for which the processing flag does not indicate processing required. By proceeding in order from the reconfiguration for the divided data for which the processing flag does not indicate processing required, the reconfiguration and the decompression processing for the divided data for which the processing flag indicates processing required are executed simultaneously, and communication delay can be reduced. The reconstruction method is not particularly limited while identification information is used. Examples of the reconstruction method include a reconstruction method of connecting the divided data in the order of serial numbers, and a reconstruction method of writing the received and decompressed data at the position of the address number of the reconstructed file. In the reconstruction method of writing the received and decompressed data at the position of the address number of the reconstructed file, it is preferable to secure a storage area of the data amount of the original data in advance.

### [Step S107: Transmit Reception Completion Information]

The control part 31 executes the reconstruction section 313 in cooperation with the storage part 32 and the communication part 33, and transmit reception completion information (Step S107). The control part 31 shifts the processing to step S101, and repeats step S101 from step S107,

### [Flowchart of Data Processing]

FIG. 10 is a flowchart illustrating an example of the flow of a group of data reception executed by, the thread capable of parallel processing according to the present embodiment.

[Step S111: Determine Whether a Divided Compressed Data has been Received]

When the execution of the group of data reception is assigned to the thread 311, the control part 31 executes the data reception section 312 in cooperation with the storage part 32 and the communication part 33, and determines whether or not a divided compressed data associated with the identification information capable of identifying the divided compressed data has been received (step S111). If it has been received, the control part 31 shifts the processing to step S112. If it has not been received, the control part 31 repeats step S111. If it has not been received, the control part 31 may repeat step S111 after waiting for a predetermined time. By waiting for a predetermined time, the load on the control part 31 and the communication part 33 is reduced, the execution speed of other threads and the time required for processing are improved, and an increase in communication delay can be prevented.

### [Step S112: Store the Divided Compressed Data in the Received Data 321]

The control part 31 executes the data reception section 312 in cooperation with the storage part 32 and the communication part 33, and associates the identification information to the divided compressed data to store in the received data 321 (Step S112). The control part 31 shifts the processing to step S113. In the example of the received data 321 illustrated in FIG. 9, the received divided compressed data is stored in the unprocessed data, and the associated identification information is stored in the identification information. The order of storing the divided compressed data is not particularly limited. Examples of the order in which the divided compressed data is stored include the order in which the divided compressed data shown in FIG. 9 is received, and the order along the serial number included in the identification information.

### [Step S113: Determine Whether a Decompression Process is Required]

Turn back to FIG. 10. The control part 31 executes the data reception section 312 in cooperation with the storage part 32 and the communication part 33, and determines whether or not a decompression process is required (Step S113). If a decompression process is required, the control part 31 shifts the processing to step S114, If a decompression process is not required, the control part 31 shifts the processing to step S116.

### [Step S114: Change Processing Flag to Processing Required]

The control part 31 executes the data reception section 312 in cooperation with the storage part 32 and the communication part 33, and changes processing flag related to the received divided compressed data stored in received data 321 to processing required (Step S114). The control part 31 shifts the processing to step S115.

### [Step S115: Execute Decompression Process]

The control part 31 executes the data reception section 312 in cooperation with the storage part 32 and the communication part 33, and executes a decompression process related to the received divided compressed data (Step S115). The control part 31 shifts the processing to step S116.

A data decompression method is not particularly limited. The data decompression method preferably includes a method of decompressing data compressed by the compression method used by the transmission side such as the transmission device 2. The data decompression method may include determination of a compression method. By including the determination of the compression method, the data can be expanded even when the compression method used by the transmission side such as the transmission device 2 is not known in advance. The data decompression method preferably includes a method using the lz4fast algorithm because the decompression speed is higher than that of LZO while the compression ratio is substantially equal to that of LZO which is a compression method excellent in decompression speed.

When the decompression process fails, the control part 31 may perform an error process of removing the corresponding divided compressed data from the received data 321. By removing the corresponding divided compressed data from the received data 321, transmission of the corresponding divided compressed data is instructed in S104 and S105. Thus, even when the divided compressed data is corrupted due to a communication error or the like and the expansion processing fails, the transmission of the corresponding divided compressed data can be promptly instructed until the expansion processing succeeds. Therefore, even when the divided compressed data is corrupted due to a communication error or the like and the decompression processing fails, the reconstruction of the original data can be realized with a smaller communication delay.

### [Step S116: Change Processing Flag to No Processing Required]

The control part 31 executes the data reception section 312 in cooperation with the storage part 32 and the communication part 33, and changes processing flag related to the received divided compressed data stored in received data 321 to no processing required (Step S116). The control part 31 shifts the processing to step S111, and repeats step S111 from step S116.

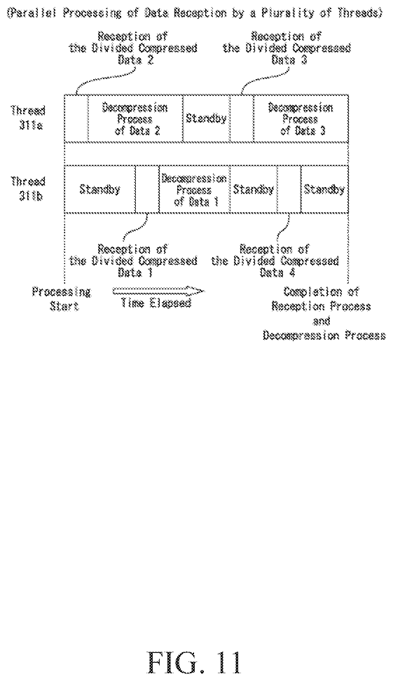

FIG. 11 is a conceptual diagram illustrating parallel processing of a group of data reception of steps S111 to S116 assigned to threads capable of parallel processing. In this example, the group of threads 311 includes two threads (a thread 311a and a thread 311b). As shown in FIG. 11, since many reception processes are executed at the same time as decompression processes of other threads that do not perform reception processes, they do not increase the processing time until completion of reception process and decompression process. Therefore, the time from the start of processing to the completion of transmission is shortened, and the communication delay can be reduced. Although FIG. 11 shows a case where the group of threads 311 has t threads, it will be understood that if the number of threads is larger, the number of decompression processes executed by other threads that are not performing reception processes during reception processes increases, and the time from the start of the process to the completion of the reception process and the decompression process becomes shorter.

Since the reception device 3 receives and decompresses the divided compressed data in the above-described procedure from step S101 to step S116 and reconstructs, it is possible to provide a data reception device that can reduce the amount of data to be transmitted to effectively use the communication band and reduce the communication delay at the same time.

### <Usage Example of Data Communication System>

A usage example of the communication system 1 according to the present embodiment will be described.

According to the present embodiment, the transmission device 2 is configured capable to connect to the reception device 3 via the network 4.

### [Transmission of Data]

The user or another program executed on the transmission device 2 instructs the transmission device 2 to transmit the transmission target data. The transmission device 2 executes the data dividing section 212 to divide the transmission target data to generate divided data. The transmission device 2 executes the identification information assignment section 213, assigns identification information to the divided data, and transmits the identification information list 222 to the reception device 3. The transmission device 2 executes the data processing section 214, and assigns a group of data processing related to the plurality of divided data to any (for example, a thread 211a) of the plurality of threads 211 capable of performing parallel processing. The thread to which the data processing is assigned compresses divided data and prepares transmission data associated with the identification information. Then, the thread to which the data processing is assigned transmits the transmission data to the reception device 3 by .a communication system without guarantee of data delivery order.

### [Data Delivery]

The transmission data is delivered to the reception device 3 via the network 4.

### [Reception of Data]

The reception device 3 executes the data reception section 312, and assigns a group of processing related to data reception to any of the plurality of threads 311 capable of performing parallel processing. The thread 311 receives the transmission data transmitted by the transmission device 2 as the divided compressed data associated with the identification information. The thread 311 performs decompression processing of the divided compressed data requiring decompression process, and generates divided data related to the decompressed divided compressed data. And divided data is generated from the divided compressed data which does not require decompression process. When all the divided compressed data is received, the reception device 3 sends the reception completion information to the transmission device 2. Then, the reconstruction section 313 is executed to reconstruct the transmission target data by using the plurality of divided data and the identification information. The reconstructed transmission target data may be used by another program executed on the reception device 3.

### [End of Data Transmission]

The transmission device 2 receives the reception completion information and ends the data transmission.

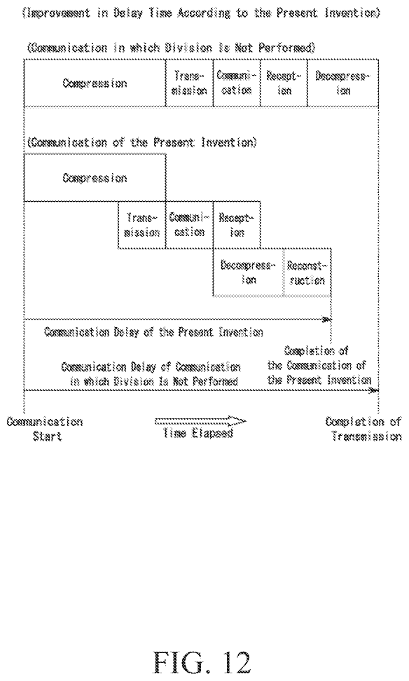

FIG. 12 is a conceptual diagram illustrating a summary of an improvement in delay time according to the present invention. In data communication in which division is not performed, compression processing, transmission processing, data transmission, reception processing, and decompression processing are sequentially performed. Therefore, the time from the start of communication related to transmission target data on the transmission side to the completion of communication in which the transmission target data can be used on the reception side is the sum of the time required for these processes and the time required for data transmission. In the data communication of the present invention, since the compression processing and the transmission processing are simultaneously performed using a plurality of threads that can be processed in parallel, the influence of the time required for the transmission processing on the communication delay can be substantially ignored. Further, in the data communication according to the present invention, since the reception process and the decompression process are simultaneously performed using a plurality of threads that can be processed in parallel, the influence of the time required for the reception process on the communication delay can be substantially ignored. Since the influence of the transmission processing and the reception processing on the communication delay can be substantially ignored, the time from the start of communication to the completion of communication can be shortened even if the time required for reconstruction is added.

Therefore, according to the data communication system 1 described in the present embodiment, it is possible to provide a data communication system that simultaneously achieves effective use of communication bandwidth by reducing the amount of data being communicated and reducing communication delay.

### Modified Examples

Hereinafter, various modified examples of the invention described in the embodiment will be exemplified.

### Modified Example 1

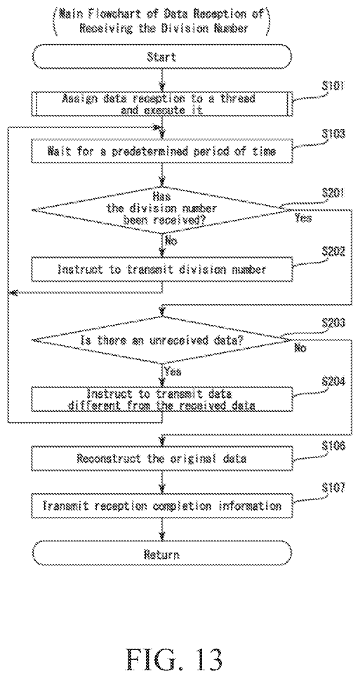

(Data reception for receiving division number of divided compressed data)
The reception device 3 according to the embodiment receives the identification information list, determines whether there: is a difference between the identification information list and the received information in step S104, and instructs transmission of information different from the received information in the identification information list in step S105, but the present invention is not limited thereto. The present modified example describes a case in which the reception device 3 does not receive the identification information list, receives the division number of the divided compressed data, and when the number of received divided compressed data is less than the division number, instructs transmission of divided compressed data that is different from the received divided compressed data. Hereinafter, with reference to FIG. 13, a procedure of data reception for receiving the division number of the divided compressed data will be described,

### [Main Flowchart of Data Reception of Receiving the Division Number of the Divided Compressed Data]

FIG. 13 is an example of a flowchart showing a procedure for performing data reception for receiving the division number of the divided compressed data in the present modified example. At least one of the divided compressed data of the present modified example includes information indicating the division number of the divided compressed data. The storage part 32 of the present modified example stores a final data division number variable for storing the division number of the divided compressed data.

### [Step S101: Assign Data Processing to a Thread and Execute It]

### [Step S103: Wait for a Predetermined Time to Elapse]

Step S101 is the same as step S101 of the basic embodiment except that the division number variable is set to indicate non-reception and the control part 31 shifts the processing to step S103. Step S103 is the same as step S103 of the basic embodiment except that the control part 31 shifts the processing to step S201.

[Step S201: Determine Whether the Division Number has been Received]

The control part 31 executes the data reception section 312 in cooperation with the storage part 32 and the communication part 33, and determines whether or not the division number has been received with referring to the division number variable (Step S201). If it indicates non-reception, the control part 31 shifts the processing to step S202. If it does not indicate non-reception, the control part 31 shifts the processing to step S203.

### [Step S202: Instruct to Transmit Division Number]

The control part 31 executes the data reception section 312 in cooperation with the storage part 32 and the communication part 33, and instructs the transmission side to transmit division number (Step S202). The control part 31 shifts the processing to step S103. By instructing the transmission side to transmit the division number, the division number can be received even if the division number is lost during transmission through the network 4 due to a communication failure or the like.

[Step S203: Determine Whether there is an Unreceived Data]

The control part 31 executes the data reception section 312 in cooperation with the storage part 32 and the communication part 33, and determines whether or not there is unreceived divided compressed data by comparing whether or not the division number variable matches the number of divided compressed data stored in the received data 321 (step S203). If there is an unreceived data, the control part 31 shifts the processing to step S204. If there is no unreceived data, the control part 31 shifts the processing to step S106.

[Step S204: Instruct to Transmit Data Different from the Received Data]

The control part 31 executes the data reception section 312 in cooperation with the storage part 32 and the communication part 33, and instructs the transmission side such as the transmission device 2 to transmit data different from the received data (Step S204). The control part 31 shifts the processing to step S106. The instruction to transmit data different from the received data preferably includes a list of identification information stored in the received data 321.

### [Step S106: Reconstruct the Original Data Using Identification Information]

### [Step S107: Transmit Reception Completion Information]

Steps S106 and S107 are the same as those in the basic embodiment.

The process of a group of data reception executed by a thread capable of parallel processing is the same as in the basic example, except that when divided compressed data containing information indicating the division number is received in step S111, the division number variable is changed to indicate the division number indicated by the received information.

In the present modified example, the reception device 3 does not receive the identification information list, receives the division number of the divided compressed data, and when the number of received divided compressed data is less than the division number, instructs transmission of divided compressed data that is different from the received divided compressed data, so that it can reconstruct data without receiving the identification information list. Therefore, the transmitting side such as the transmission device 2 does not need to transmit the identification information list. This reduces the amount of data to be communicated and allows for more effective use of communication band.

### Modified Example 2

(Data reception for receiving information capable of determining whether all of the divided compressed data has been received)
The present modified example describes a case in which the reception device 3 receives information capable of determining whether all of the divided compressed data has been received, and instructs transmission of divided compressed data different from the received divided compressed data unless all of the divided compressed data has been received. The information capable of determining whether all of the divided compressed data has been received is not particularly limited. Examples of the information capable of determining whether all of the divided compressed data has been received include a hash value of the divided compressed data, a checksum of the divided compressed data, and a data amount of original data.
[Main Flowchart of Data Reception of Receiving Information Capable of Determining Whether all of the Divided Compressed Data has been Received]

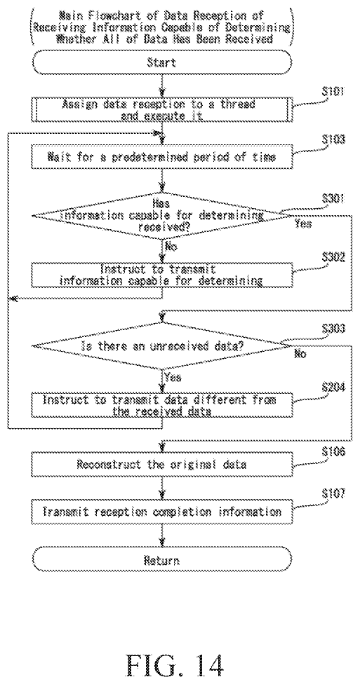

FIG. 14 is an example of a flowchart illustrating a procedure for performing data reception for receiving information capable of determining whether all of the divided compressed data has been received. At least one of the divided compressed data of the present modified example includes information capable of determining whether all of the divided compressed data has been received. The storage part 32 of the present modified example stores reception completion determination information that stores information capable of determining whether all of the divided compressed data has been received.

### [Step S101: Assign Data Processing to a Thread and Execute It]

### [Step S103: Wait for a Predetermined Time to Elapse]

Step S101 is the same as step S101 of the basic embodiment except that the reception completion determination information is set to indicate non-reception and the control part 31 shifts the processing to step S103. Step S103 is the same as step S103 of the basic embodiment except that the control part 31 shifts the processing to step S301.

[Step S301: Determine Whether it has been Received Information Capable for Determining Whether all of the Divided Compressed Data have been Received]

The control part 31 executes the data reception section 312 in cooperation with the storage part 32 and the communication part 33, and determines whether or not it has been received information capable for determining whether all of the divided compressed data have been received with referring to the reception completion determination information (Step S301). If it indicates non-reception, the control part 31 shifts the processing to step S302. If it does not indicate non-reception, the control part 31 shifts the processing to step S303.

[Step S302: Instruct to Transmit Information Capable for Determining Whether all of the Divided Compressed Data have been Received]

The control part 31 executes the data reception section 312 in cooperation with the storage part 32 and the communication part 33, and instructs the transmission side to transmit information capable for determining whether all of the divided compressed data have been received (Step S302). The control part 31 shifts the processing to step S103. By instructing the transmission side to transmit the information capable for determining whether all of the divided compressed data have been received, the information capable for determining whether all of the divided compressed data have been received can be received even if the information capable for determining whether all of the divided compressed data have been received is lost during transmission via the network 4 due to a communication failure or the like.

[Step S303: Determine Whether there is an Unreceived Data]

The control part 31 executes the data reception section 312 in cooperation with the storage part 32 and the communication part 33, and determines whether or not there is unreceived divided compressed data by comparing reception completion determination information with the received data 321 (step S203). If there is an unreceived data, the control part 31 shifts the processing to step S204. If there is no unreceived data, the control part 31 shifts the processing to step S106. A method of comparing the reception completion determination information with the received data 321 is not particularly limited.

[Step S204: Instruct to transmit data different from the received data]

### [Step S106: Reconstruct the Original Data Using Identification Information]

### [Step S107: Transmit Reception Completion Information]

The step S204 is the same as in the modified example 1. Steps S106 and S107 are the same as those in the basic embodiment.

In the present modified example, the reception device 3 does not receive a list of identification information, but receives information capable for determining whether all of the divided compressed data have been received, and when it has not received all the divided compressed data, it instructs the transmission of divided compressed data that is different from the received divided compressed data, so that it can reconstructed the data without receiving the identification information. Therefore, the transmitting side such as the transmission device 2 does not need to transmit the identification information list. This reduces the amount of data to be communicated and allows for more effective use of communication band.

### Modified Example 3

(Data Reception for Executing Reconstructing Process with a Plurality of Threads Capable of Parallel Processing)

In the present modified example, a case will be described in which the reception device 3 executes the reconfiguration process with a plurality of threads capable of parallel processing. It is preferable that the identification information list 322 of the present modified example preferably includes the data amount of the original data and the data amount of the divided data related to the divided compressed data.

[Main Flowchart of Data Reception for Executing Reconstructing Process with a Plurality of Threads Capable of Parallel Processing]
[Step S101: Assign data processing to a thread and execute it]
[Step S102: Determine whether an identification information list has been received]
[Step S103: Wait for a predetermined time to elapse]
[Step S104: Determine whether there is a difference between the identification information list and the received data]
[Step S105: Instruct to transmit data different from the received data in the identification information list]
[Step S107: Transmit reception completion information]

Step S101 is the same as the basic embodiment, except that the group of data-receiving further includes a reconstruction process. Steps S102, S103, S105 and S107 are the same as those in the basic embodiment. Step S104 is the same as in the basic embodiment except that the process shifts to step S107 when there is no difference between the identification information list 322 and the received data 321 described below

### [Flowchart of Data Processing]

In the procedure of a group of data reception executed by the thread capable of parallel processing in the present modified example, the following processing is performed after step S116.

### [Step S117: Reconstruct the Original Data Using Identification Information]

The control part 31 executes the reconstruction section 313 in cooperation with the storage part 32, and reconstructs the original data using identification information (Step S117). The control part 31 shifts the processing to step S111, and repeats step S111 from step S117. The reconstruction method is not particularly limited while identification information is used. Examples of the reconstruction method include a reconstruction method of connecting the divided data in the order of serial numbers, and a reconstruction method of writing the received and decompressed data at the position of the address number of the reconstructed file. The reconstruction method preferably includes a reconstruction method of writing the received and decompressed data at the position of the address number of the reconstructed file. In the case of the reconstruction method in which the received and decompressed data is written at the position of the address number of the reconstructed file, a plurality of reconstruction processes can be simultaneously executed. It can further reduce the communication delay.

Since the reception device 3 according to the present modification executes the reconfiguration process in a plurality of threads capable of parallel processing, the reconfiguration process can be performed during the reception process or during the time when the reception device 3 waits for reception of data as illustrated in FIG. 11. Therefore, it is possible to further reduce waste of time during reception processing and waste of time during waiting for data reception. It allows to provide a data reception device that simultaneously achieves effective use of communication bandwidth by reducing the amount of data being communicated and reducing communication delay.

Although the respective embodiments and various modifications of the present invention have been described above, the present invention is not limited to the aforementioned embodiments and modifications. In addition, the effects described in the aforementioned various embodiments of the present invention merely recite the most preferred effects derived from the present invention, and the effects of the present invention are not limited to those described in the aforementioned various embodiments and modifications of the present invention.

In addition, the aforementioned various embodiments have been described in detail to explain the present invention in an easy-to-understand manner, and are not necessarily limited to those having all the described configurations. Further, for one embodiment, it is possible to replace some of a configuration thereof with a configuration of another embodiment. Moreover, for one embodiment, it is also possible to add the configuration of another embodiment to the configuration thereof.

### DESCRIPTION OF THE REFERENCE NUMERALS

1 Data Communication System
2 Data Transmission Device
21 Control Part
211 Group of Threads
211a Thread
211b Thread
212 Data Dividing Section
213 Identification Information Assignment Section
214 Data Processing Section
22 Storage Part
221 Transmission Target Data
222 Identification Information List
23 Communication Part
3 Data Reception Device
31 Control Part
311 Group of Threads
311a Thread
311b Thread
312 Data Reception Section
313 Reconstruction Section
32 Storage Part
321 Received Data
322 Identification Information List
33 Communication Part
4 Network

1. A program making a data reception device execute:
a data reception step assigning a group of data reception from an outside to any of a plurality threads capable of parallel processing to be executed,
wherein the group of data reception includes:
a divided compressed data reception process of receiving a plurality of divided compressed data obtained by dividing original data into a plurality of divided data and compressing specified divided data, and each of the plurality of divided compressed data is identifiable by identification information;
a decompress process of decompressing the received plurality of divided compressed data; and
a reconstructing process of reconstructing the original data from the decompressed divided compressed data,
wherein the group of data reception further includes: a list receiving process of receiving a list of the identification information from the outside, and
the program making the data reception device further execute a transmission instructing step of instructing the outside to transmit one or more data different from the plurality of divided compressed data received in the divided compressed data reception process among the data group associated with the list of identification information.

2. The data transmission device according to claim 1, wherein the communication system without guarantee of data delivery order includes one or both of a User Datagram Protocol (UDP) and a Stream Control Transmission Protocol (SCTP).

3. A program making a data transmission device execute:
a data dividing step of dividing data to be transmitted into a plurality of divided data pieces;
an identification information assignment step of associating identification information for identifying the plurality of divided data pieces with each of the plurality of divided data pieces; and
a data processing step of assigning a group of data processing for the plurality of divided data to any of a plurality of threads capable of parallel processing to be executed,
wherein the group of data processing includes:
a transmission data preparation process of compressing divided data pieces having a data capacity equal to or larger than a predetermined capacity among the plurality of divided data pieces and preparing a plurality of transmission data pieces associated with the identification information; and
a transmitting process of transmitting the plurality of transmission data pieces to the outside by a communication system without guarantee of data delivery order.

4. A program making a data reception device execute:
a data reception step assigning a group of data reception from an outside to any of a plurality of threads capable of parallel processing to be executed; and
a data reconstruction step of reconstructing the data received in the data reception step,
wherein the group of data reception includes:
a divided compressed data reception process of receiving a plurality of divided compressed data pieces obtained by dividing original data into a plurality of divided data pieces and compressing specified divided data piece, and each of the plurality of divided compressed data pieces is identifiable by identification information; and
a decompress process of decompressing the received plurality of divided compressed data,
wherein the data reconstruction step includes a process of reconstructing the original data from the decompressed divided compressed data pieces.

5. A program making a data reception device execute:
a data reception step assigning a group of data reception from an outside to any of a plurality of threads capable of parallel processing to be executed,
wherein the group of data reception includes:
a divided compressed data reception process of receiving a plurality of divided compressed data obtained by dividing original data into a plurality of divided data and compressing specified divided data, and each of the plurality of divided compressed data is identifiable by identification information;
a decompress process of decompressing the received plurality of divided compressed data; and
a reconstruction process of reconstructing the original data from the decompressed divided compressed data.

6. The program according to claim 5, wherein the group of data reception further includes: a list receiving process of receiving a list of the identification information from the outside, and
the program further configured to cause the data reception device to perform a transmission instruction step of instructing the outside to transmit one or more data different from the plurality of divided compressed data pieces received in the divided compressed data reception process among a data group associated with the list of identification information.

7. A data communication system comprises a data transmission device according to claim 1, and
a data reception device receiving data from the data transmission device,
wherein the data reception device has:
a data reception section of assigning a group of data reception from the data transmission device to any of a plurality of threads capable of parallel processing to be executed; and
a reconstruction section of reconstructing the data received in the data receiving step,
wherein the group of data reception includes:
a divided compressed data reception process of receiving a plurality of divided compressed data obtained by dividing original data into a plurality of divided data and compressing specified divided data, and each of the plurality of divided compressed data is identifiable by identification information;
a decompress process of decompressing the received plurality of divided compressed data; and
wherein the reconstruction section includes reconstructing the original data from the decompressed divided compressed data pieces.
